(19) United States
(12) Patent Application Publication
(10) Pub. No.: US 2008/0201160 A1
(43) Pub. Date: Aug. 21, 2008

(54) Method for Managing Car Lease Using Car-Use Electronic Device and Mobile Device

(75) Inventor: Wei Chang, Hsinchu City (TW)

Correspondence Address: WPAT, PC, 7225 BEVERLY ST., ANNANDALE, VA, 22003, US

(73) Assignee: MSTAR SEMICONDUCTOR, INC., Hsinchu Hsien (TW)

(21) Appl. No.: 11/941,137

(22) Filed: Nov. 16, 2007

(30) Foreign Application Priority Data
Feb. 16, 2007 (TW) 096105994

(51) Int. Cl. G06Q 10/00

(52) U.S. Cl. 705/1

(57) ABSTRACT

A method for managing car lease using a car-use electronic device and a mobile device, comprising steps of: picking up a car data from a data base for matching so as to provide a first data comprising a car password and a second data comprising a user password when an information center receives a renting request, wherein the car password and the user password are matched; transmitting the first data to the mobile device of a user and the second data to a controller on a car; and authorizing the user to star the car if the controller verifies that the car password and the user password are matched after the user transmits the car password from the mobile device to the controller.

### BACKGROUND OF THE INVENTION

1. Field of the Invention

The present invention generally relates to a method for managing car lease and, more particularly, to a method for managing car lease using the interaction between a car-use electronic device and a mobile device for controlling car pickup/return.

2. Description of the Prior Art

In a modern society, the car and the mobile phone are the most frequently used appliances since they reduce time for reaching a destination and communication. However, there is little interaction between the car and the mobile phone. The car-use electronic device only allows the user to use the mobile phone with the speaker and the microphone inside the car.

In a car lease service, the car lease service provider often requires a large space for parking the automobiles for lease and hires personnel to manage car pickup/return, which increases the cost of space and manpower. Moreover, the leaseholder has to go to the car lease service provider for car pickup and then drive the car back for car return after he/she has finished using the car, which causes great inconvenience and increases the cost of time and money.

Therefore, there is a need in providing a method for managing car lease using the interaction between a car-use electronic device and a mobile device to reduce the cost of space and manpower for the car lease service provider and the cost of time and money for the leaseholder.

### SUMMARY OF THE INVENTION

It is one object of the present invention to provide a method for managing car lease using the interaction between a car-use electronic device and a mobile device for controlling car pickup/return so as to reduce the cost of time and money.

In order to achieve the foregoing object, the present invention provides a method for managing car lease using a car-use electronic device and a mobile device, comprising steps of: picking up a car data from a data base for matching so as to provide a first data comprising a car password and a second data comprising a user password when an information center receives a renting request, wherein the car password and the user password are matched; transmitting the first data to the mobile device of a user and the second data to a controller on a car; and authorizing the user to star the car if the controller verifies that the car password and the user password are matched after the user transmits the car password from the mobile device to the controller.

It is preferably that the method for managing car lease further comprises steps of: transmitting an end signal from the controller to the information center so as to stop and lock the car after the user has finished using the car; and updating the lease data in the data base when the information center receives the end signal.

It is preferably that the first data comprises a car pickup location and a car pickup time.

It is preferably that the user transmits the renting request to the information center through a network service, a telephone service or a mobile communication service using the mobile device.

It is preferably that the mobile device is a mobile phone.

It is preferably that the controller comprises a global positioning system (GPS).

It is preferably that the mobile device communicates with the controller using Bluetooth or near-field communication (NFC).

It is preferably that the controller communicates with the information center using general packet radio service (GPRS) or third generation (3G) communication.

It is preferably that the information center communicates with the mobile device using global system for mobile (GSM) communication, general packet radio service (GPRS) or third generation (3G) communication.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic diagram of a car lease system using a car-use electronic device and a mobile device; and

FIG. 2 is a flow-chart showing a method for managing car lease using a car-use electronic device and a mobile device according to the present invention.

### DETAILED DESCRIPTION OF THE PREFERRED EMBODIMENT

The present invention discloses a method for managing car lease using a car-use electronic device and a mobile device and can be exemplified by the preferred embodiment as described hereinafter.

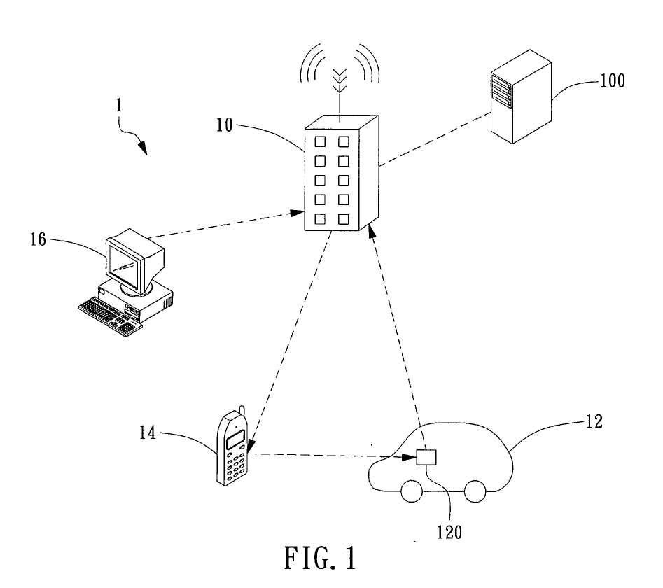

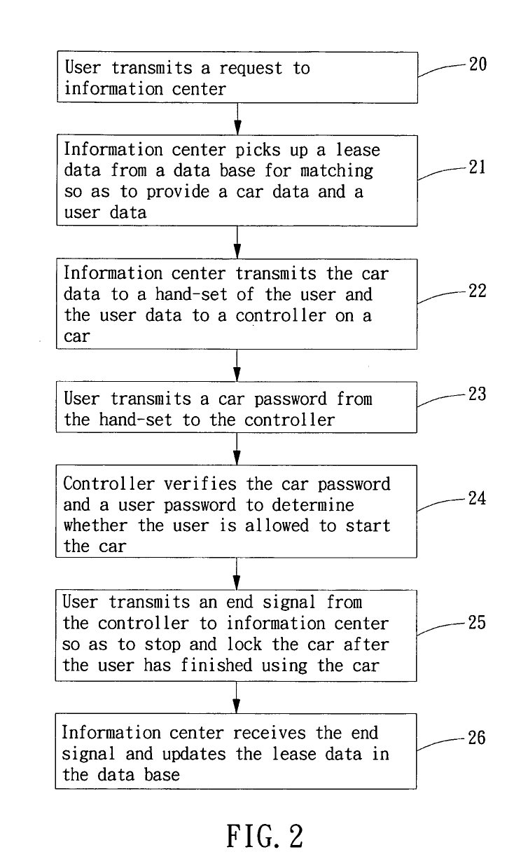

Please refer to FIG. 1 and FIG. 2, wherein FIG. 1 is a schematic diagram of a car lease system using a car-use electronic device and a mobile device and, FIG. 2 is a flow-chart showing a method for managing car lease using a car-use electronic device and a mobile device according to the present invention.

In FIG. 1, the car lease system 1 of the present invention comprises an information center 10, a car 12 and a mobile phone 14 of a user. The information center 10 is coupled to a data base 100 storing at least a lease data for all cars (including the car 12). The lease data comprises the car type, current car location, leaseholder data and current status. The car 12 has a controller 120 installed thereon.

In Step 20 in FIG. 2, the user (not shown in FIG. 1) transmits a renting request to the information center 10 when he/she wants to rent a car. The renting request comprises the requested car type, requested car renting time, and current car location (or requested car pickup location). The user uses the computer 16 to request the information center 10 for renting a car.

In Step 21, the information center 10 picks up a lease data from the data base 100 for matching so as to provide a car data (a first data, not shown in FIG. 1) and a user data (a second data, not shown in FIG. 1). The car data comprises the car ID, car pickup time, car pickup location and car password. The user data comprises the user password. The car password and the user password are matched. The system selects the car data of a car that is nearest to the user and conforms to the user's requirement. Therefore, the user can pick up the nearest car for less cost of time.

In Step 22, the information center 10 transmits the car data to the mobile phone 14 of the user and the user data to the controller 120 on the car 12.

At a pre-determined time, the user brings the mobile phone 14 to the car pickup location where the car 12 is parked. The user transmits the car password from the mobile phone 14 to the controller 140, as described in Step 23.

The controller 140 verifies the car password and the user password to determine whether they are matched after the controller 120 receives the car password. The user is authorized to star the car 12 if the controller 140 verifies that the car password and the user password are matched, as described in Step 24.

So far, a simple and efficient car pickup process is finished.

Furthermore, to complete the whole car lease process, a car return process is included to comprise the steps described hereinafter:

In Step 25, the user starts the controller 120 to transmit an end signal to the information center 10 so that the car 12 is stopped and locked accordingly after the user has finished using the car 12. The end signal comprises the car ID and current car location.

The information center 10 updates the lease data in the data base 100 after the information center 10 receives the end signal so that the next leaseholder can request for car renting, as described in Step 26.

In this method, the car return process can be finished with minimal manpower and the user does not have to drive the car back to where the car is rented for checking out.

Certainly, those with ordinary skills in the art can make modifications within the scope of the present invention. In one embodiment of Step 25, the user transmits an end signal from the mobile phone 14 to the information center 10 so that the information center 10 transmits a stop signal to the controller 120 to stop and lock the car 12 after the user has finished using the car 12. The end signal comprises the car ID and current car location.

In another embodiment of Step 25, the user transmits a stop signal from the mobile phone 14 to the controller 120 so that the controller 120 transmits an end signal to the information center 10 to stop and lock the car 12 after the user has finished using the car 12. The end signal comprises the car ID and current car location.

In the present invention, in addition to using a computer for communication, the user can use a telephone service or a mobile communication with a mobile device to transmit the renting request to the information center. The controller on the car can comprise a global positioning system (GPS) so as to report the current car location to the information center. Furthermore, the mobile device communicates with the controller using Bluetooth or near-field communication (NFC); the controller communicates with the information center using general packet radio service (GPRS) or third generation (3G) communication; and the information center communicates with the mobile device using global system for mobile (GSM) communication, general packet radio service (GPRS) or third generation (3G) communication.

Certainly, the afore-mentioned communication tools are only described as examples. Usage of any other communication tool with the method of the present invention is within the scope thereof.

Accordingly, the present invention discloses a method for managing car lease that overcomes the problems in conventional car lease methods to reduce the cost of space and manpower for the car lease service provider and the cost of time and money for the customer.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for managing car lease using a car-use electronic device and a mobile device, comprising steps of:
picking up a car data from a data base for matching so as to provide a first data comprising a car password and a second data comprising a user password when an information center receives a renting request, wherein the car password and the user password are matched;
transmitting the first data to the mobile device of a user and the second data to a controller on a car; and
authorizing the user to star the car if the controller verifies that the car password and the user password are matched after the user transmits the car password from the mobile device to the controller.

2. The method for managing car lease as recited in claim 1, further comprising steps of:
transmitting an end signal from the controller to the information center so as to stop and lock the car after the user has finished using the car; and
updating the lease data in the data base when the information center receives the end signal.

3. The method for managing car lease as recited in claim 1, further comprising steps of:
transmitting an end signal from the mobile device to the information center so that the information center transmits a stop signal to the controller to stop and lock the car after the user has finished using the car, wherein the end signal comprises a car ID and a current car location; and
updating the lease data in the data base when the information center receives the end signal.

4. The method for managing car lease as recited in claim 1, further comprising steps of:
transmitting a stop signal from the mobile device to the controller so that the controller transmits an end signal to the information center to stop and lock the car after the user has finished using the car, wherein the end signal comprises a car ID and a current car location; and
updating the lease data in the data base when the information center receives the end signal.

5. The method for managing car lease as recited in claim 1, wherein the first data comprises a car pickup location and a car pickup time.

6. The method for managing car lease as recited in claim 1, wherein the renting request comprises a requested car type, requested car renting time, and a requested car pickup location.

7. The method for managing car lease as recited in claim 1, further comprising a step of:
transmitting the renting request to the information center.

8. The method for managing car lease as recited in claim 7, wherein the user transmits the renting request to the information center through a network service.

9. The method for managing car lease as recited in claim 7, wherein the user transmits the renting request to the information center through a telephone service.

10. The method for managing car lease as recited in claim 7, wherein the user transmits the renting request to the information center through a mobile communication service using the mobile device.

11. The method for managing car lease as recited in claim 1, wherein the mobile device is a mobile phone.

12. The method for managing car lease as recited in claim 1, wherein the controller comprises a global positioning system (GPS).

13. The method for managing car lease as recited in claim 1, wherein the mobile device communicates with the controller using Bluetooth.

14. The method for managing car lease as recited in claim 1, wherein the mobile device communicates with the controller using near-field communication (NFC).

15. The method for managing car lease as recited in claim 1, wherein the controller communicates with the information center using general packet radio service (GPRS).

16. The method for managing car lease as recited in claim 1, wherein the controller communicates with the information center using third generation (3G) communication.

17. The method for managing car lease as recited in claim 1, wherein the information center communicates with the mobile device using global system for mobile (GSM) communication.

18. The method for managing car lease as recited in claim 1, wherein the information center communicates with the mobile device using general packet radio service (GPRS).

19. The method for managing car lease as recited in claim 1, wherein the information center communicates with the mobile device using third generation (3G) communication.
